(19) United States
(12) Patent Application Publication
(10) Pub. No.: US 2018/0212281 A1
(43) Pub. Date: Jul. 26, 2018

(54) LITHIUM SECONDARY BATTERY INCLUDING AN ADDITIVE

(71) Applicants: Samsung Electronics Co., Ltd., Suwon-si (KR); Samsung SDI Co., Ltd., Yongin-si (KR)

(72) Inventors: Basab ROY, Hwaseong-si (KR); Myongchun Koh, Hwaseong-si (KR); Dongyoung Kim, Yongin-si (KR); Yeonji Chung, Yongin-si (KR)

(21) Appl. No.: 15/472,548

(22) Filed: Mar. 29, 2017

(30) Foreign Application Priority Data
Jan. 24, 2017 (KR) 10-2017-0011140

(51) Int. Cl. H01M 10/42; H01M 10/0525; H01M 10/0567; H01M 4/525; H01M 10/0568; H01M 4/505; H01M 4/587; H01M 10/0569

(52) U.S. Cl. CPC H01M 10/4235; H01M 10/0525; H01M 10/0567; H01M 4/525; H01M 10/0568; H01M 2300/0034; H01M 4/587; H01M 10/0569; H01M 2300/004; H01M 2300/0042; H01M 4/505

(57) ABSTRACT

A lithium secondary battery including a cathode; an anode; and an electrolyte disposed between the cathode and the anode,
wherein the cathode includes a cathode active material represented by Formula 1,
the electrolyte includes a lithium salt; a non-aqueous solvent; and a disilane compound represented by Formula 2, and
wherein an amount of the disilane compound is about 5 percent by weight (wt %) or less, based on the total weight of the electrolyte:

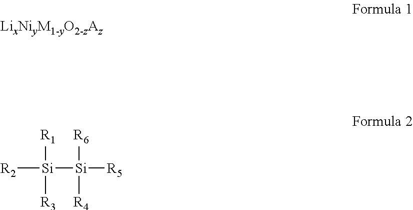

wherein, in Formula 1 and 2, 0.95≤x≤1.2, 0.7≤y≤0.95, and 0≤z<0.2, M is aluminum, magnesium, manganese, cobalt, iron, chromium, vanadium, titanium, copper, boron, calcium, zinc, zirconium, niobium, molybdenum, strontium, antimony, tungsten, bismuth, or a combination thereof; and A is at least one anion having an oxidation number of −1 or −2.

### CROSS-REFERENCE TO RELATED APPLICATION

This application claims priority to and the benefit of Korean Patent Application No. 10-2017-0011140, filed on Jan. 24, 2017, in the Korean Intellectual Property Office, and all the benefits accruing therefrom under 35 U.S.C. § 119, the content of which is incorporated herein in its entirety by reference.

### BACKGROUND

### 1. Field

The present disclosure relates to a lithium secondary battery including an additive.

### 2. Description of the Related Art

Lithium secondary batteries are used as power sources of portable electronic devices, such as camcorders, mobile phones, and laptop computers. Rechargeable lithium secondary batteries have an energy density per unit weight which is about three times greater than that of lead storage batteries, nickel-cadmium (Ni—Cd) batteries, nickel-hydrogen batteries, or nickel-zinc batteries, and may be charged at high rates.

A lithium-containing metal oxide is used as a cathode active material in a cathode of a lithium secondary battery. For example, a composite oxide of lithium and a metal selected from cobalt, manganese, nickel (Ni), and a combination thereof may be used as a cathode active material. Ni-rich cathode active materials containing a large amount of Ni can be used to provide a battery having a greater capacity than a battery including a lithium-cobalt oxide. Thus, studies on Ni-rich cathode active materials are underway.

However, in case of Ni-rich cathode active material, a surface structure of the cathode active material may be weak, and thus the cathode active material may have poor lifespan characteristics and increased resistance.

Therefore, there remains a need for a lithium secondary battery which exhibits improved capacity, excellent lifespan characteristics, and low resistance.

### SUMMARY

Provided is a lithium secondary battery having a novel structure.

Additional aspects will be set forth in part in the description which follows and, in part, will be apparent from the description, or may be learned by practice of the presented embodiments.

According to an aspect of an embodiment, a lithium secondary battery includes a cathode; an anode; and an electrolyte disposed between the cathode and the anode, wherein the cathode includes a cathode active material represented by Formula 1, wherein the electrolyte includes a lithium salt; a non-aqueous solvent; and a disilane compound represented by Formula 2, and

wherein an amount of the disilane compound is about 5 percent by weight (wt %) or less based on the total weight of the electrolyte,

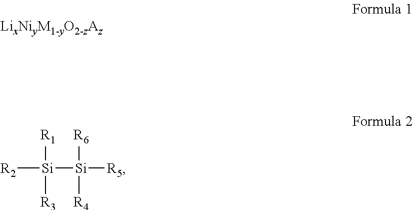

wherein, in Formulae 1 and 2,
0.95≤x≤1.2, 0.7≤y≤0.95, and 0≤z<0.2;
M is aluminum (Al), magnesium (Mg), manganese (Mn), cobalt (Co), iron (Fe), chromium (Cr), vanadium (V), titanium (Ti), copper (Cu), boron (B), calcium (Ca), zinc (Zn), zirconium (Zr), niobium (Nb), molybdenum (Mo), strontium (Sr), antimony (Sb), tungsten (W), bismuth (Bi), or a combination thereof, and
A is at least one anion having an oxidation number of −1 or −2; and
R₁ to R₆ are each independently a substituted or unsubstituted linear or branched C₁-C₃₀ alkyl group or a substituted or unsubstituted C₆-C₆₀ aryl group,
wherein a substituent of the substituted C₁-C₃₀ alkyl group or C₆-C₆₀ aryl group, if present, is a halogen, a methyl group, an ethyl group, a propyl group, an iso-propyl group, an n-butyl group, an iso-butyl group, a t-butyl group, a trifluoromethyl group, a tetrafluoroethyl group, a vinyl group, a propenyl group, a butenyl group, or a combination thereof.

These and/or other aspects will become apparent and more readily appreciated from the following description of the embodiments.

### DETAILED DESCRIPTION

Reference will now be made in detail to embodiments, wherein like reference numerals refer to like elements throughout. In this regard, the present embodiments may have different forms and should not be construed as being limited to the descriptions set forth herein. Accordingly, the embodiments are merely described below to explain aspects. As used herein, the term “and/or” includes any and all combinations of one or more of the associated listed items. “Or” means “and/or.” Expressions such as “at least one of,” when preceding a list of elements, modify the entire list of elements and do not modify the individual elements of the list.

It will be understood that when an element is referred to as being “on” another element, it can be directly on the other element or intervening elements may be present therebetween. In contrast, when an element is referred to as being “directly on” another element, there are no intervening elements present.

It will be understood that, although the terms “first,” “second,” “third,” etc. may be used herein to describe various elements, components, regions, layers, and/or sections, these elements, components, regions, layers, and/or sections should not be limited by these terms. These terms are only used to distinguish one element, component, region, layer, or section from another element, component, region, layer, or section. Thus, “a first element,” “component,” “region,” “layer,” or “section” discussed below could be termed a second element, component, region, layer, or section without departing from the teachings herein.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “At least one” is not to be construed as limiting “a” or “an.” It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10% or 5% of the stated value.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Hereinafter, a lithium secondary battery according to an embodiment will be described in further detail.

According to an embodiment, a lithium secondary battery includes a cathode; an anode; and an electrolyte disposed between the cathode and the anode,

wherein the cathode includes a cathode active material represented by Formula 1,
wherein the electrolyte includes a lithium salt; a non-aqueous solvent; and a disilane-based compound represented by Formula 2, and
wherein an amount of the disilane-based compound is about 5 percent by weight (wt %) or less based on the total weight of the electrolyte,

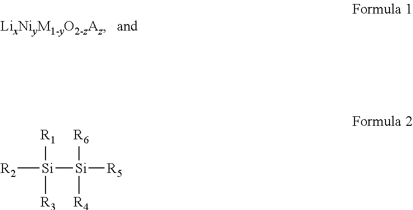

In Formulae 1 and 2,

0.95≤x≤1.2, 0.7≤y≤0.95, and 0≤z<0.2;
M is aluminum (Al), magnesium (Mg), manganese (Mn), cobalt (Co), iron (Fe), chromium (Cr), vanadium (V), titanium (Ti), copper (Cu), boron (B), calcium (Ca), zinc (Zn), zirconium (Zr), niobium (Nb), molybdenum (Mo), strontium (Sr), antimony (Sb), tungsten (W), bismuth (Bi), or a combination thereof;
A is at least one anion having an oxidation number of −1 or −2; and
R₁ to R₆ are each independently a substituted or unsubstituted linear or branched C₁-C₃₀ alkyl group or a substituted or unsubstituted C₆-C₆₀ aryl group,
wherein, if present, a substituent of the substituted C₁-C₃₀ alkyl group or C₆-C₆₀ aryl group is a halogen, a methyl group, an ethyl group, a propyl group, an iso-propyl group, an n-butyl group, an iso-butyl group, a t-butyl group, a trifluoromethyl group, a tetrafluoroethyl group, a vinyl group, a propenyl group, a butenyl group, or a combination thereof.

A Ni-rich lithium metal oxide, such as the cathode represented by Formula 1, which is capable of providing a high capacity battery, when otherwise used in a battery, the battery may suffer poor lifespan characteristics and increased resistance due to increased amount of Ni³⁺ cations. In order to resolve such problem, the lithium secondary battery may include the disilane-based compound represented by Formula 2. While not wanting to be bound by theory, it is understood that the disilane-based compound may form a Li-rich solid electrolyte interface (SEI) layer on a surface of an anode, and thus the resistance may be decreased.

In particular, the Si—Si bond in the disilane-based compound may be broken easily by lithium. The Si—Si bond in the disilane-based compound may be dissociated during lithium insertion into the anode during a charge/discharge process of the lithium secondary battery, and two Si—Li components are formed per one disilane-based compound. The Si—Li components may involve in reaction(s) for forming an SEI layer on a surface of the anode. As a result, the Li-rich SEI layer described above may be formed, which may decrease an internal resistance of the lithium secondary battery. Since, Li-rich SEI layer is formed on the surface of the anode, battery performance may improve.

When amount of the disilane-based compound included in the electrolyte is greater than 5 percent by weight (wt %), based on the total weight of the electrolyte, the Si—Si bond containing disilane compound together with active material generated from the High-Ni cathode may interact with the Li insertion process to the anode. As a result, lithium cations may be consumed without being involved in battery characteristics. In order to resolve such problem, the lithium secondary battery may limit an amount of the disilane-based compound to 5 wt % or less, based on the total weight of the electrolyte, and thus may exhibit improved capacity and while having excellent lifespan characteristics and low resistance. On the other hand, when the amount of the disilane-based compound is very small, Li-rich SEI layer formation may be insufficient, and thus decrease in resistance as mentioned above, may not be achieved up to the desired level.

For example, the disilane-based compound may be included by an amount in a range of about 0.1 wt % to about 3 wt %, based on the total weight of the electrolyte. For example, the disilane-based compound may be included by an amount in a range of about 0.1 wt % to about 2 wt %, based on the total weight of the electrolyte. For example, the disilane-based compound may be included by an amount in a range of about 0.2 wt % to about 1.5 wt %, based on the total weight of the electrolyte. For example, the disilane-based compound may be included by an amount in a range of about 0.5 wt % to about 1.5 wt %, based on the total weight of the electrolyte.

In an embodiment, R₁ to R₆ may be each independently a substituted or unsubstituted C₁-C₁₀ alkyl group, a substituted or unsubstituted C₆-C₃₀ aryl group, or a combination thereof.

The substituted or unsubstituted C₁-C₃₀ alkyl group may be, for example,

a methyl group, an ethyl group, a propyl group, an isopropyl group, a butyl group, a tert-butyl group, or a combination thereof; or
a methyl group, an ethyl group, a propyl group, an isopropyl group, a butyl group, or a tert-butyl group, or a combination thereof, each substituted with a halogen, a methyl group, an ethyl group, a propyl group, an isopropyl group, a butyl group, a tert-butyl group, a trifluoromethyl group, a tetrafluoroethyl group, a vinyl group, a propenyl group, a butenyl group, or a combination thereof.

But embodiments are not limited thereto. Also, a combination comprising at least one of the foregoing may be used.

The substituted or unsubstituted C₆-C₆₀ aryl group may be, for example,

a phenyl group, a biphenyl group, a terphenyl group, or a combination of; and
a phenyl group, a biphenyl group, a terphenyl group, or a combination thereof, each substituted with a halogen, a methyl group, an ethyl group, a propyl group, an isopropyl group, a butyl group, a tert-butyl group, a trifluoromethyl group, a tetrafluoroethyl group, a vinyl group, a propenyl group, a butenyl group, or a combination thereof.

But embodiments are not limited thereto. Also, a combination comprising at least one of the foregoing may be used.

In an embodiment, the disilane-compound may be any of Compounds 1 to 3, or combination thereof:

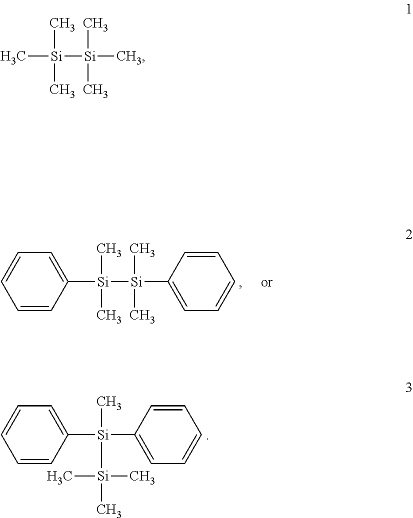

As described above, the Si—Si bond may be easily dissociated by introducing an electron donating group to the disilane-based compound, and through this, formation of the Li-rich SEI layer may be facilitated.

The electrolyte includes a lithium salt. The lithium salt may be dissolved in an organic solvent and function as a source of lithium ions in the battery. For example, the lithium salt may promote migration of lithium ions between the cathode and the anode.

An anion of the lithium salt in the electrolyte may be PF₆⁻, BF₄⁻, SbF₆⁻, AsF₆⁻, C₄F₉SO₃⁻, ClO₄⁻, AlO₂⁻, AlCl₄, CₓF₂ₓ₊₁SO₃⁻ (where x is a natural number), (CₓF₂ₓ₊₁SO₂)(C_{y}F_{2y+1}SO₂)N⁻ (where x and y are each a natural number), a halide, or a combination thereof.

For example, the lithium salt may be difluoro(oxalate)borate (LiDFOB), LiBF₄, LiPF₆, LiCF₃SO₃, (CF₃SO₂)₂NLi, (FSO₂)₂NLi, or a combination thereof. In some embodiments, the lithium salt may be LiDFOB or LiPF₆.

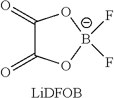

In some embodiments, the lithium salt may include LiDFOB and LiPF₆, and an amount of LiDFOB may be about 2 wt % or less, based on the total weight of the electrolyte.

For example, the lithium salt may comprise (FSO₂)₂NLi or LiPF₆. In particular, the lithium salt may include (FSO₂)₂NLi and LiPF₆, and amount of (FSO₂)₂NLi may be about 10 wt % or less, based on the total weight of the electrolyte.

The lithium salt in a non-solvent-containing electrolyte may be included in an amount in a range of about 0.001 wt % to about 30 wt %, based on the total weight of the non-solvent-containing electrolyte, but embodiments are not limited to this range. The lithium salt in a non-solvent-containing electrolyte may be used in any suitable amount that may enable the electrolyte to effectively transfer lithium ions and/or electrons in a charge/discharge process.

A concentration of the lithium salt in a solvent-containing electrolyte may be in a range of about 100 millimolar (mM) to about 10 molar (M). For example, the concentration may be in a range of about 100 mM to about 2 M. For example, concentration may be in a range of about 500 mM to about 2 M. However, the concentration is not limited to these ranges, and the lithium salt in a solvent-containing electrolyte may be used at any suitable concentration that may enable the electrolyte to effectively transfer lithium ions and/or electrons in a charge/discharge process.

The non-aqueous solvent may be a carbonate-based solvent, an ester-based solvent, an ether-based solvent, a ketone-based solvent, an aprotic solvent, or a combination thereof. Examples of the carbonate-based solvent include dimethyl carbonate (DMC), diethyl carbonate (DEC), ethylmethyl carbonate (EMC), dipropyl carbonate (DPC), methylpropyl carbonate (MPC), ethylpropyl carbonate (EPC), ethylene carbonate (EC), propylene carbonate (PC), butylene carbonate (BC), and tetraethylene glycol dimethyl ether (TEGDME). Examples of the ester-based solvent include methyl acetate, ethyl acetate, n-propyl acetate, dimethyl acetate, methyl propionate, ethyl propionate, γ-butyrolactone, decanolide, valerolactone, mevalonolactone, and caprolactone. Examples of the ether-based solvent include dibutyl ether, tetraglyme, diglyme, dimethoxyethane, 2-methyl tetrahydrofuran, and tetrahydrofuran. An example of the ketone-based solvent may be cyclohexanone. A combination comprising at least one of the foregoing may be used.

The aprotic solvent may be used alone or in a mixture of at least one of the aprotic solvents. When the mixture of at least one of the aprotic solvents is used, a mixing ratio thereof may be appropriately adjusted according to performance of a battery, which may be understood by one of ordinary skill in the art and determined without undue experimentation.

When the carbonate-based solvent is used, a mixture of linear carbonate and cyclic carbonate may be used. In this case, performance of the electrolyte may be excellent when the linear carbonate and the cyclic carbonate are mixed at a volume ratio of about 1:1 to about 9:1.

In some embodiments, a fluoro-ethylene carbonate (FEC), vinylene carbonate (VC), vinylethylene carbonate (VEC), a phosphine compound, a phosphite compound, a phosphate compound, propane sultone (PS), or a combination of may further be included in the non-aqueous solvent.

For example, the non-aqueous solvent may include FEC. For example, the lithium secondary battery may include FEC at an amount of about 7 volume % (vol %) or less, based on the total volume of the non-aqueous solvent. For example, the lithium secondary battery may include FEC at an amount in a range of about 0.5 vol % to about 7 vol %, based on the total volume of the non-aqueous solvent. For example, the lithium secondary battery may include FEC at an amount in a range of about 1 vol % to about 7 vol %, based on the total volume of the non-aqueous solvent. For example, the lithium secondary battery may include FEC at an amount in a range of about 2 vol % to about 7 vol %, based on the total volume of the non-aqueous solvent.

For example, the electrolyte may further include VC, VEC, maleic anhydride, succinic anhydride, or a mixture thereof. In some embodiments, the lithium secondary battery may further include VC, VEC, maleic anhydride, succinic anhydride, or a mixture thereof at an amount less than about 2 wt %, based on the total weight of the electrolyte. For example, the lithium secondary battery may further include VC, VEC, maleic anhydride, succinic anhydride, or a mixture thereof at an amount in a range of about 0.1 wt % to about 2 wt %, based on the total weight of the electrolyte. For example, the lithium secondary battery may further include VC, VEC, maleic anhydride, succinic anhydride, or a mixture thereof at an amount in a range of about 0.1 wt % to about 1 wt %, based on the total weight of the electrolyte.

In an embodiment, the electrolyte may further include maleic anhydride, but embodiments are not limited thereto.

For example, the electrolyte may further include a phosphorus (P)-containing compound, a sulfur (S)-containing compound, or a mixture thereof. For example, the electrolyte may include the P-containing compound, the S-containing compound, or a mixture thereof, in an amount of about 2 wt % or less, based on the total weight of the electrolyte. For example, the electrolyte may further include the P-containing compound, the S-containing compound, or a mixture thereof, in an amount in a range of about 0.1 wt % to about 2 wt %, based on the total weight of the electrolyte. For example, the electrolyte may further include the P-containing compound, the S-containing compound, or a mixture thereof, in an amount in a range of about 0.1 wt % to about 1.5 wt %, based on the total weight of the electrolyte.

The P-containing compound may be a phosphine compound, a phosphate compound, a phosphite compound, or a combination thereof, and the S-containing compound may be a disulfonate compound. For example, the P-containing compound may be a phosphate compound or a phosphite compound, and the S-containing compound may be a disulfonate compound, but embodiments are not limited thereto. A combination comprising the P-containing compound and the S-containing compound may be used.

The phosphine compound may be, for example, triphenylphosphine, tris(4-fluorophenyl) phosphine, tris(2,4-difluorophenyl)phosphine, or tris(perfluorophenyl)phosphine, but embodiments of the phosphine compound are not limited thereto. The phosphate compound may be, for example, trimethyl phosphate (TMP), triethyl phosphate, tripropyl phosphate, or tributyl phosphate, but embodiments of the phosphate compound are not limited thereto. The phosphite compound may be, for example, triethyl phosphite (TEPi), trimethyl phosphite, tripropyl phosphite, tributyl phosphite, or tris(trimethylsilyl)phosphite, but embodiments are not limited thereto.

The disulfonate compound may be, for example, methylene methane disulfonate (MMDS) or busulfan, but embodiments are not limited thereto.

A combination comprising at least one of the foregoing may be used.

As described above, in the case of Ni-rich lithium metal oxide such as the cathode represented by Formula 1 which is capable of providing a high capacity battery, when used in a battery, the battery may suffer poor lifespan characteristics and increased resistance due to increase in amount of Ni³⁺ cations. While not wanting to be bound by theory, it is understood that when the lithium secondary battery may include the disulfonate compound, sulfonate reacts with Ni³⁺ cations, and thus the Ni³⁺ cations are stabilized, which may result in decrease of resistance. When amount of the disulfonate compound is greater than 2 wt %, based on the total weight of the electrolyte, disulfonate may react with lithium cations generated from the cathode active material, resulting in consumption of lithium cations without being involved in battery characteristics.

The disilane-based compound represented by Formula 2 may be easily decomposed by reactions on anode. In addition, as will be described later, the lithium secondary battery comprising an anode active material that includes a metal alloyable with lithium or a carbonaceous anode active material, there is a problem of gas generation and resulting life characteristic reduction, due to the catalytic function at high temperatures. As described above, when FEC, VC, VEC, a P-containing compound, or a S-containing compound is included in the battery within the ranges mentioned above, a passivation layer, e.g., an SEI layer, containing product(s) of chemical reaction(s) involving these compounds may be formed on the anode, partly or on the whole surface of the anode. Since the gas generation may be prevented during high-temperature preservation due to formation of such SEI layer, safety and performance of the battery may improve.

Hereinafter, the configuration of the lithium secondary battery will further be described in detail.

The cathode may include the cathode active material represented by Formula 1, and, for example, A in Formula 1 may be selected from halogen, S, and N, but embodiments are not limited thereto.

In some embodiments, in Formula 1, 0.8≤y≤0.95.

In some embodiments, the cathode active material may be represented by Formula 3 or 4:

LiₓNi_{y′}Co_{1-y′-z′}Al_{z′}O₂, Formula 3

LiₓNi_{y′}Co_{1-y′-z′}Mn_{z′}O₂. Formula 4

In Formulae 3 and 4, 0.9<x′<1.2, 0.8≤y′≤0.95, 0<z′<0.1, and 0<1-y′-z′<0.2.

For example, the cathode may include Li_{1.02}Ni_{0.85}Co_{0.1}Mn_{0.05}O₂, Li_{1.02}Ni_{0.88}C_{0.08}Mn_{0.04}O₂, Li_{1.02}Ni_{0.88}Co_{0.08}Al_{0.04}O₂ LiNi_{0.8}Co_{0.15}Al_{0.05}O₂, LiNi_{0.88}Co_{0.1}Al_{0.02}O₂, LiNi_{0.85}Co_{0.1}Al_{0.05}O₂, LiNi_{0.8}Co_{0.15}Mn_{0.05}O₂, LiNi_{0.88}Co_{0.1}Mn_{0.02}O₂, and LiNi_{0.85}Co_{0.1}Mn_{0.05}O₂ as a cathode active material. For example, the cathode may include at least one selected from Li_{1.02}Ni_{0.85}Co_{0.1}Mn_{0.05}O₂, Li_{1.02}Ni_{0.88}C_{0.08}Mn_{0.04}O₂, Li_{1.02}Ni_{0.88}Co_{0.08}Al_{0.04}O₂, or a combination thereof as a cathode active material, but embodiments are not limited thereto.

Also, the cathode may further include lithium cobalt oxide, lithium nickel cobalt manganese oxide, lithium nickel cobalt aluminum oxide, lithium iron phosphate, lithium manganese oxide, or a combination thereof in addition to the aforementioned cathode active materials, but embodiments of the cathode active materials are not limited thereto. Any suitable cathode active material available in the art may further be included in the cathode.

In some embodiments, the cathode active material may comprise a compound represented by one of the following formulae: LiₐA_{1-b}B′_{b}D′₂ (where 0.90≤a≤1.8, and 0≤b≤0.5); LiₐE_{1-b}B_{b}O_{2-c}D_{c} (where 0.90≤a≤1.8, 0≤b≤0.5, and 0≤c≤0.05); LiE_{2-b}B′_{b}O_{4-c}D_{c} (where 0≤b≤0.5, and 0≤c≤0.05); LiₐNi_{1-b-c}CO_{b}B′_{c}D′_{α} (where 0.90≤a≤1.8, 0≤b≤0.5, 0≤c≤0.05, and 0≤a≤2); LiₐNi_{1-b-c}CO_{b}B′_{c}O_{2-α}F′_{α} (where 0.90≤a≤1.8, 0≤b≤0.5, 0≤c≤0.05, and 0≤α≤2); LiₐNi_{1-b-c}Co_{b}B′_{c}O₂₋ₐF′₂ (where 0.90≤a≤1.8, 0≤b≤0.5, 0≤c≤0.05, and 0≤α≤2); LiₐNi_{1-b-c}Mn_{b}B′_{c}D′_{α} (where 0.90≤a≤1.8, 0≤b≤0.5, 0≤c≤0.05, and 0≤α≤2); LiₐNi_{1-b-c}Mn_{b}B_{c}O₂₋ₐF′ₐ (where 0.90≤a≤1.8, 0≤b≤0.5b, 0≤c≤0.05, and 0≤α≤2); LiₐNi_{1-b-c}Mn_{b}B′_{c}O₂₋ₐF′₂ (where 0.90≤a≤1.8, 0≤b≤0.5, 0≤c≤0.05, and 0≤α≤2); LiₐNi_{b}E_{c}G_{d}O₂ (where 0.90≤a≤1.8, 0≤b≤0.9, 0≤c≤0.5, and 0.001≤d≤0.1); LiₐNi_{b}Co_{c}Mn_{d}GeO₂ (where 0.90≤a≤1.8, 0≤b≤0.9, 0≤c≤0.5, 0≤d≤0.5, and 0.001≤e≤0.1); LiₐNiG_{b}O₂ (where 0.90≤a≤1.8, and 0.001≤b≤0.1); LiₐCoG_{b}O₂ (where 0.90≤a≤1.8, and 0.001≤b≤0.1); LiₐMnG_{b}O₂ (where 0.90≤a≤1.8, and 0.001≤b≤0.1); LiₐMn₂G_{b}O₄ (where 0.90≤a≤1.8, and 0.001≤b≤0.1); QO₂; QS₂; LiQS₂; V₂O₅; LiV₂O₅; LiIO₂; LiNiVO₄; Li_{(3-f)}J₂ (PO₄)₃ (where 0≤f≤2); Li_{(3-f)}Fe₂ (PO₄)₃ (where 0≤f≤2); and LiFePO₄. A combination comprising at least one of the foregoing may be used.

In the formulae above, A may be nickel (Ni), cobalt (Co), manganese (Mn), or a combination thereof; B may be aluminum (Al), nickel (Ni), cobalt (Co), manganese (Mn), chromium (Cr), iron (Fe), magnesium (Mg), strontium (Sr), vanadium (V), a rare earth element, or a combination thereof; D may be s oxygen (O), fluorine (F), sulfur (S), phosphorus (P), or a combination thereof; E may be cobalt (Co), manganese (Mn), or a combination thereof; F may be fluorine (F), sulfur (S), phosphorus (P), or a combination thereof; G may be aluminum (Al), chromium (Cr), manganese (Mn), iron (Fe), magnesium (Mg), lanthanum (La), cerium (Ce), strontium (Sr), vanadium (V), or a combination thereof; Q is titanium (Ti), molybdenum (Mo), manganese (Mn), or a combination thereof; I is chromium (Cr), vanadium (V), iron (Fe), scandium (Sc), yttrium (Y), or a combination thereof; and J may be vanadium (V), chromium (Cr), manganese (Mn), cobalt (Co), nickel (Ni), copper (Cu), or a combination thereof.

A cathode may be prepared in the following manner.

The cathode may be prepared by applying, drying, and pressing a cathode active material on a cathode current collector. In addition to the above-described cathode active materials, a cathode active material composition in which binder and solvent are mixed may be prepared, if desired.

The cathode active material composition may further include a conducting agent or filler.

In some embodiments, the cathode active material composition may be directly coated on a metallic current collector to prepare a cathode plate. In some embodiments, the cathode active material composition may be cast on a separate support to form a cathode active material film, which may then be separated from the support and laminated on a metallic current collector to prepare a cathode plate.

In some embodiments, loading level of the prepared cathode active material composition may be about 30 milligrams per square centimeter (mg/cm²) or greater, or, in particular, about 35 mg/cm² or greater, or in particular, about 40 mg/cm² or greater. In addition, an electrode density thereof may be about 3 grams per cubic centimeter (g/cc) or greater, or, in particular, about 3.5 g/cc or greater.

In an embodiment, in order to achieve a high cell energy density, a loading level of the prepared cathode active material composition may be in a range of about 35 mg/cm² or greater to about 50 mg/cm² or less, and an electrode density thereof may be in a range of about 3.5 g/cc or greater to about 4.2 g/cc or less.

In another embodiment, both surfaces of the cathode electrode plate may be coated with the cathode active material composition at a loading level of about 37 mg/cm² and at an electrode density of about 3.6 g/cc.

When loading level and an electrode density of the cathode active material composition are within these ranges, a battery including the cathode active material may have an improved cell energy density of about 500 watt-hours per liter (Wh/L) or greater. For example, the battery may have a cell energy density in a range of about 500 Wh/L to about 900 Wh/L.

Examples of the solvent are N-methyl-pyrrolidone, acetone, and water, but embodiments are not limited thereto. An amount of the solvent may be in a range of about 10 parts to about 100 parts by weight, based on 100 parts by weight of the cathode active material. When the amount of the solvent is within this range, a process for forming the cathode active material layer may be performed efficiently.

Amount of the conducting agent may be in a range of about 1 wt % to about 30 wt %, based on the total weight of the mixture including a cathode active material. The conducting agent may be any suitable material having suitable electrical conductivity that does not cause an undesirable chemical change in a battery. Examples of the conducting agent include graphite, such as natural graphite or artificial graphite; a carbonaceous material, such as carbon black, acetylene black, Ketjen black, channel black, furnace black, lamp black, or summer black; conductive fibers, such as carbon fibers or metal fibers; a metal powder of fluorinated carbon, aluminum, or nickel; a conductive whisker, such as zinc oxide or potassium titanate; a conductive metal oxide, such as titanium oxide; and a conductive material, such as a polyphenylene derivative.

The binder is a component which may assist in bonding of an active material to a conducting agent and to a current collector, and may be added at an amount of about 1 wt % to about 30 wt %, based on the total weight of a mixture including a cathode active material. Examples of the binder may include polyvinylidene fluoride (PVdF), polyvinylidene chloride, polybenzimidazole, polyimide, polyvinyl acetate, polyacrylonitrile, polyvinyl alcohol, carboxymethyl cellulose (CMC), starch, hydroxypropyl cellulose, regenerated cellulose, polyvinyl pyrrolidone, tetrafluoro ethylene, polyethylene, polypropylene, polystyrene, polymethyl methacrylate, polyaniline, acrylonitrile butadiene styrene, phenol resin, epoxy resin, polyethylene terephthalate, polytetrafluoroethylene, polyphenyl sulfide, polyamideimide, polyetherimide, polyether sulfone, polyamide, polyacetal, polyphenylene oxide, polybutylene terephthalate, an ethylene-propylene-diene monomer (EPDM), a sulfonated EPDM, a styrene-butadiene rubber, a fluorine rubber, and various suitable copolymers, but embodiments are not limited thereto. The filler may optionally be included as a component for suppressing expansion of a cathode. The filler may not be particularly limited, and may be any suitable fibrous material that does not cause an undesirable chemical change in a battery. For example, a fibrous material, such as an olefin-based polymer, e.g., polyethylene or polypropylene; glass fibers; or carbon fibers, may be used as a filler

Amounts of the cathode active material, the conducting agent, the filler, the binder, and the solvent may be in ranges that are commonly used in lithium batteries. At least one of the conducting agent, the filler, the binder, and the solvent may be omitted according to the use and the structure of the lithium battery.

In some embodiments, N-methylpyrrolidone (NMP) may be used as a solvent, PVdF or PVdF copolymer may be used as a binder, and carbon black or acetylene black may be used as a conducting agent. For example, 94 wt % of a cathode active material, 3 wt % of a binder, and 3 wt % of a conducting agent may be mixed in a powder form, and then NMP may be added thereto such that slurry is formed with a solid content of 70 wt %. This slurry may then be coated, dried, and roll-pressed to prepare a cathode electrode plate.

The cathode current collector may be prepared to have a thickness in a range of about 3 micrometers (μm) to about 50 μm. The cathode current collector is not particularly limited, and may be any suitable material as long as the cathode current collector has suitable electrical conductivity and does not cause an undesirable chemical change in a battery. Examples of the cathode current collector include stainless steel, aluminum, nickel, titanium, and sintered carbon; and aluminum or stainless steel, the aluminum and the stainless steel each being surface-treated with carbon, nickel, titanium, or silver. The cathode current collector may be processed to have fine bumps on surfaces thereof, so as to enhance a binding force of the cathode active material to the current collector. The cathode current collector may be used in any of various suitable forms such as a film, a sheet, a foil, a net, a porous body, foam, and a non-woven fabric.

In some embodiments, the anode may include an anode active material including a metal alloyable with lithium and/or a carbonaceous anode active material.

In some embodiments, the anode active material including a metal alloyable with lithium may include silicon (Si), a silicon-carbon composite material including Si particles, SiO_{a′} (wherein 0<a′<2), or a combination thereof.

In some embodiments, the Si particles in the silicon-carbon composite material may have an average diameter of 200 nanometers (nm) or less.

In some embodiments, a capacity of the Si—C composite material may be in a range of about 300 mAh/g to about 700 mAh/g. In some embodiments, a capacity of the Si—C composite material may be in a range of about 400 mAh/g to about 600 mAh/g.

Examples of the anode active material include, in addition to the aforementioned anode active materials, Sn, Al, Ge, Pb, Bi, Sb, a Si—Y′ alloy (wherein Y′ may be an alkali metal, an alkaline earth-metal, a Group XIII element, a Group XIV element, a transition metal, a rare-earth element, or a combination thereof, and Y′ may not be Si), and a Sn—Y′ alloy (wherein Y′ may be an alkali metal, an alkaline earth-metal, a Group XIII element, a Group XIV element, a transition metal, a rare-earth element, or a combination thereof, and Y may not be Sn). Y′ may be Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Ge, P, As, Sb, Bi, S, Se, Te, Po, or a combination thereof.

An anode may be prepared in the following manner.

The anode may be prepared by applying, drying, and pressing an anode active material on an anode current collector. In addition to the above-described anode active materials, an anode active material composition in which a binder and a solvent are mixed may be prepared, if necessary.

The anode active material composition may further include a conducting agent or filler.

In one or more embodiments, the binder, the solvent, the conducting agent, and the filler used for the cathode material composition may also be used for the anode active material composition.

Water may also be used as a solvent in the anode active material composition. In some embodiments, water may be used as a solvent; CMC, SBR, acrylate, or a methacrylate-based polymer may be used as a binder; and carbon black or acetylene black may be used as a conducting agent. For example, 94 wt % of an anode active material, 3 wt % of a binder, and 3 wt % of a conducting agent may be mixed in a powder form, and then water may be added thereto such that slurry is formed with a solid content of 70 wt %. This slurry may be then coated, dried, and roll-pressed to prepare an anode plate.

The loading level of the prepared anode active material composition may be determined depending on a loading level of the cathode active material composition.

In some embodiments, a loading level of the anode active material composition may be, depending on capacity per gram, about 12 mg/cm² or greater, and in some embodiments, about 15 mg/cm² or greater. An electrode density thereof may be about 1.5 g/cc or greater, and in some embodiments, about 1.6 g/cc or greater.

When the loading level and an electrode density of the anode active material composition are within any of these ranges, a battery including the anode active material may have a high cell energy density of about 500 Wh/L or greater.

The anode current collector may be, in general, prepared to have a thickness in a range of about 3 μm to about 50 μm. The anode current collector is not particularly limited, and may be any suitable material as long as the anode current collector has suitable electrical conductivity and does not cause an undesirable chemical change in a battery. Examples of the anode current collector may include copper, stainless steel, aluminum, nickel, titanium, and sintered carbon; copper or stainless steel, the copper and the stainless steel each being surface-treated with carbon, nickel, titanium, or silver; and an aluminum-cadmium alloy. In addition, like the cathode current collector, the anode current collector may be processed to have fine bumps on surfaces of the anode current collector to enhance a binding force of the anode active material to the current collector. The anode current collector may be used in any of various suitable forms such as a film, a sheet, a foil, a net, a porous body, foam, and a non-woven fabric.

In an embodiment, the lithium secondary battery may exhibit a direct current internal resistance (DCIR) increasing rate of less than about 140% after 200 charge/discharge cycles at a temperature of about 45° C. under a charge/discharge current of 1 C/1 C, an operating voltage in a range of about 2.8 volts (V) to about 4.3 V, and a cut-off current of 1/10 C in a constant current-constant voltage (CC-CV) mode.

That is, as compared with conventional Ni-rich lithium secondary batteries, the lithium secondary battery may have a significantly low DCIR increasing rate. Accordingly, the lithium secondary battery may exhibit excellent battery characteristics.

For example, an operating voltage of the lithium secondary battery may be in a range of about 2.8 V to about 4.3 V.

For example, an energy density of the lithium secondary battery may be about 500 Wh/L or greater.

In an embodiment, the lithium secondary battery may further include a separator between the cathode and the anode. The separator may be an insulating thin film having excellent ion permeability and mechanical strength. The separator may have a pore diameter in a range of about 0.001 μm to about 1 μm in general, and a thickness thereof may be in a range of about 3 μm to about 30 μm in general. Examples of the separator may include a chemically resistant and hydrophobic olefin-based polymer, e.g., polypropylene; and a sheet or non-woven fabric formed of glass fiber or polyethylene. When a solid electrolyte such as a polymer is used as an electrolyte, the solid electrolyte may also serve as a separator.

The electrolyte may further include, in addition to the aforementioned electrolyte, a solid electrolyte and an inorganic solid electrolyte.

Examples of the organic solid electrolyte may include a polyethylene derivative, a polyethylene oxide derivative, a polypropylene oxide derivative, a phosphoric acid ester polymer, a polyester sulfide, a polyvinyl alcohol, PVdF, and a polymer including a dissociable ionic group.

Examples of the inorganic solid electrolyte may include a nitride, a halide, and a sulfate of lithium such as Li₃N, LiI, Li₅NI₂, Li₃N—LiI—LiOH, LiSiO₄, LiSiO₄—LiI—LiOH, Li₂SiS₃, Li₄SiO₄, Li₄SiO₄—LiI—LiOH, or Li₃PO₄—Li₂S—SiS₂.

The lithium secondary battery may be prepared by a general method known in the art, that is, the lithium secondary battery may be prepared by injecting an electrolyte between a cathode and an anode.

The aforementioned cathode, anode, and separator may be wound or folded, and then sealed in a battery case. Then, the battery case may be filled with an electrolyte and then sealed by a cap assembly member, to thereby complete the preparation of a lithium secondary battery. The battery case may be a cylindrical type, a rectangular type, or a thin-film type.

The lithium secondary battery may be classified as a winding type or a stack type depending on a structure of electrodes, or as a cylindrical type, a rectangular type, a coin type, or a pouch type, depending on an exterior shape thereof.

Methods of manufacturing a lithium secondary battery are widely known in the art, and details of the method can be determined by one of skill in the art without undue experimentation, and thus a detailed description thereof is omitted.

According to another aspect, a battery module may include the lithium secondary battery as a unit cell.

According to another aspect, a battery pack may include the battery module.

According to another aspect, a device may include the battery pack. Examples of the device may include power tools powered by an electric motor; electric cars, e.g., electric vehicles (EVs), hybrid electric vehicles (HEVs), plug-in hybrid electric vehicles (PHEVs); electric two-wheeled vehicles, e.g., e-bikes and e-scooters; electric golf carts; and power storage systems, but embodiments are not limited thereto.

Further, the lithium secondary battery may be used in any applications that require high-power output, high-voltage, and operation under high-temperature conditions.

Hereinafter example embodiments will be described in detail with reference to Examples and Comparative Examples. These examples are provided for illustrative purposes only and are not intended to limit the scope of the inventive concept.

### EXAMPLES

### Example 1

### (Preparation of Cathode)

Li_{1.02}Ni_{0.85}Co_{0.1}Mn_{0.05}O₂ as a cathode active material, carbon black as a conducting agent, and PVdF as a binder were mixed and dispersed at a weight ratio of 94:3:3 in NMP, and the mixture was dispersed at a loading level of 37 mg/cm² per surface to coat both surfaces of an aluminum foil having a thickness of 12 μm, dried, and then roll-pressed to prepare a cathode having an electrode density of 3.6 g/cc.

### (Preparation of Anode)

Graphite, CMC, and SBR were mixed and dispersed at a weight ratio of 98:1.5:0.5 in water, and the mixture was dispersed at a loading level of 21.42 mg/cm² per surface to coat both surfaces of a copper foil having a thickness of 10 μm, dried, and then roll-pressed to prepare a cathode having an electrode density of 1.65 g/cc.

### (Preparation of Electrolyte)

1 wt % of VC and 1 wt % of Compound 1 based on the total weight of the electrolyte were added to a mixture including 1.15 M of LiPF₆ and EC, EMC, and DMC (at a volume ratio of 2:4:4), and thus an electrolyte was prepared.

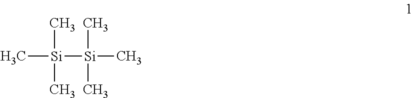

### (Preparation of Lithium Secondary Battery)

A separator having a thickness of 16 μm formed of polypropylene was disposed between the cathode and the anode, and the electrolyte was injected thereto, thereby preparing a lithium secondary battery.

### Comparative Example 1

A lithium secondary battery was prepared in the same manner as in Example 1, except that an electrolyte was prepared without adding Compound 1.

### Comparative Example 2

A lithium secondary battery was prepared in the same manner as in Example 1, except that an electrolyte was prepared by adding 1 wt % of hexamethylenediisocyanate (HMDI), instead of Compound 1, based on the total weight of the electrolyte.

### Comparative Example 3

A lithium secondary battery was prepared in the same manner as in Example 1, except that an electrolyte was prepared by adding 1 wt % of methanesulfonylflorude, instead of Compound 1, based on the total weight of the electrolyte.

### Example 2

### (Preparation of Cathode)

Li_{1.02}Ni_{0.88}Co_{0.08}Al_{0.04}O₂ as a cathode active material, carbon black as a conducting agent, and PVdF as a binder were mixed and dispersed at a weight ratio of 94:3:3 in NMP, and both surfaces of an aluminum foil having a thickness of 12 μm were coated with the mixture at a loading level of 37 mg/cm² per surface, dried, and then roll-pressed to prepare a cathode having an electrode density of 3.6 g/cc.

### (Preparation of Anode)

SCN 1 (a material designed to exhibit a capacity of 650 mAh/g by carbon-coating after dispersing Si particles having a size of ca150 nm on graphite particles, available from BTR), graphite, CMC, and SBR were mixed and dispersed at a weight ratio of 25:73:1.5:0.5 in water. Both surfaces of a copper foil having a thickness of 10 μm were coated at a loading level of 18.42 mg/cm² per surface, dried, and then roll-pressed to prepare an anode having an electrode density of 1.65 g/cc. Here, SCN 1 had Si particles on graphite.

### (Preparation of Electrolyte)

An electrolyte was prepared by adding 1 wt % of VC, 1 wt % of LiDFOB, and 1 wt % of Compound 1 based on the total weight of the electrolyte to a mixture including 1.15 M of LiPF₆ and EC, FEC, EMC, and DMC (at a volume ratio of 7:7:46:40).

### (Preparation of Lithium Secondary Battery)

A separator having a thickness of 16 μm formed of polypropylene was disposed between the cathode and the anode, and the electrolyte was injected thereto, thereby preparing a lithium secondary battery.

### Example 3

A lithium secondary battery was prepared in the same manner as in Example 2, except that an electrolyte was prepared by adding 1 wt % of Compound 2, instead of Compound 1, based on the total weight of the electrolyte.

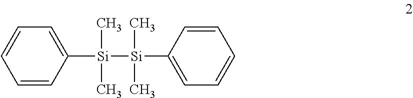 [SMILES: C[Si](C)(c1ccccc1)[Si](C)(C)c1ccccc1]

### Comparative Example 4

A lithium secondary battery was prepared in the same manner as in Example 2, except that an electrolyte was prepared without adding Compound 1 and LiDFOB.

### Comparative Example 5

A lithium secondary battery was prepared in the same manner as in Example 2, except that an electrolyte was prepared without adding Compound 1 and LiDFOB but adding 1 wt % of HMDI based on the total weight of the electrolyte.

### Example 4

A lithium secondary battery was prepared in the same manner as in Example 3, except that an electrolyte was prepared without adding LiDFOB but adding 0.2 wt % of maleic anhydride (MA), 1 wt % of TMP, and 0.4 wt % of MMDS based on the total weight of the electrolyte.

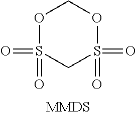

### Example 5

### (Preparation of Cathode)

A cathode was prepared in the same manner as in Example 1, except that Li_{1.02}Ni_{0.88}Co_{0.08}Mn_{0.04}O₂ was used instead of Li_{1.02}Ni_{0.85}Co_{0.1}Mn_{0.05}O₂ as a cathode active material.

### (Preparation of Anode)

The anode prepared in Example 1 was used.

### (Preparation of Electrolyte)

An electrolyte was prepared by adding 1 wt % of VC and 1 wt % of Compound 2 based on the total weight of the electrolyte in a mixture including 1.15 M of LiPF₆ and EC, FEC, EMC, and DMC (at a volume ratio of 7:7:46:40).

### (Preparation of Lithium Secondary Battery)

A separator having a thickness of 16 μm formed of polypropylene was disposed between the cathode and the anode, and the electrolyte was injected thereto, thereby preparing a lithium secondary battery.

### Comparative Example 6

A lithium secondary battery was prepared in the same manner as in Example 5, except that the electrolyte was prepared without adding Compound 2.

### Comparative Example 7

A lithium secondary battery was prepared in the same manner as in Example 5, except that the electrolyte was prepared by adding 1 wt % of HMDI, instead of Compound 2, based on the total weight of the electrolyte.

### Example 6

### (Preparation of Cathode)

The cathode prepared in Example 5 was used.

### (Preparation of Anode)

SCN 2 (a material designed to exhibit a capacity of 1300 mAh/g by carbon-coating after dispersing Si particles having a size of ca100 nm on graphite particles, available from BTR), graphite, CMC, and SBR were mixed and dispersed at a weight ratio of 13:85:1.5:0.5 in water. Both surfaces of a copper foil having a thickness of 10 μm were coated at a loading level of 18.42 mg/cm² per surface, dried, and then roll-pressed to prepare an anode having an electrode density of 1.65 g/cc. Here, SCN 2 had Si particles on the graphite and inside the graphite as well.

### (Preparation of Electrolyte)

An electrolyte was prepared in the same manner as in Example 5, except that 1 wt % of TEPi was added based on the total weight of the electrolyte.

### (Preparation of Lithium Secondary Battery)

A separator having a thickness of 16 μm formed of polypropylene was disposed between the cathode and the anode, and the electrolyte was injected thereto, thereby preparing a lithium secondary battery.

### Example 7

A lithium secondary battery was prepared in the same manner as in Example 5, except that the electrolyte was prepared without adding Compound 2 but adding 1 wt % of MA, 1 wt % of TMP, 0.4 wt % of MMDS, and 1 wt % of Compound 1 based on the total weight of the electrolyte.

### Example 8

A lithium secondary battery was prepared in the same manner as in Example 5, except that 1 wt % of busulfan based on the total weight of the electrolyte was added.

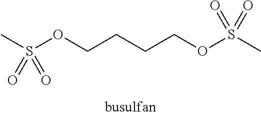

### Comparative Example 8

A lithium secondary battery was prepared in the same manner as in Example 7, except that LiCoO₂ was used as a cathode active material.

### Comparative Example 9

A lithium secondary battery was prepared in the same manner as in Example 7, except that LiNi_{0.5}Co_{0.45}Al_{0.05} was used as a cathode active material.

### Comparative Example 10

A lithium secondary battery was prepared in the same manner as in Example 1, except that 5.5 wt % of Compound 1 was added, instead of 1 wt % of Compound 1, to prepare the electrolyte.

### Evaluation Example 1: Evaluation of Lifespan and Resistance

The lithium secondary batteries prepared in Examples 1 to 8 and Comparative Examples 1 to 10 were subject to 200 charge/discharge cycles at a temperature of 45° C., under a charge/discharge current of 1 C/1 C, an operating voltage in a range of about 2.8 V to about 4.3 V, and a cut-off current of 1/10 C in a CC-CV mode. Then, DCIR increasing rates and lifespans of the lithium secondary batteries were evaluated. The results of the evaluation are shown in Table 1. Here, a lifespan was determined by calculating a ratio of a capacity after 200^{th} charge/discharge cycles based on a capacity after the 1^{st} charge/discharge cycle under the same conditions.

TABLE 1

| | Lifespan | DCIR increasing rate |
|---|---|---|
| | (%) | (%) |
| Example 1 | 84.3 | 129 |
| Comparative Example 1 | 80.6 | 148 |
| Comparative Example 2 | 78.2 | 162 |
| Comparative Example 3 | 78.7 | 153 |
| Example 2 | 81.3 | 126 |
| Example 3 | 79.8 | 125 |
| Comparative Example 4 | 79.6 | 145 |
| Comparative Example 5 | 77.9 | 162 |
| Example 4 | 82.6 | 116 |
| Example 5 | 83.5 | 136 |
| Comparative Example 6 | 81.6 | 158 |
| Comparative Example 7 | 78.8 | 152 |
| Example 6 | 76.1 | 138 |
| Example 7 | 77.4 | 117 |
| Example 8 | 75.2 | 135 |
| Comparative Example 8 | 68.2 | 162 |
| Comparative Example 9 | 71.4 | 158 |
| Comparative Example 10 | 74.5 | 178 |

Referring to Table 1, the lithium secondary batteries of Examples 1 to 8 were found to have increased lifespans and decreased DCIR increasing rates, compared to those of the lithium secondary batteries of Comparative Examples 1 to 7 including no disilane compound under the same conditions. That is, the lithium secondary batteries of Examples 1 to 8 were found to have decreased resistance while exhibiting excellent lifespan characteristics.

In the cases of the lithium secondary batteries of Comparative Examples 2, 3, 5, and 7 including HMDI or methane sulfonyl fluoride, instead of the disilane compound, the DCIR increasing rates did not decrease, but increased in some cases, and the lifespans were found to be decreased. When HMDI or methane sulfonyl fluoride, is used in a combination with Ni-rich cathode, a thin film is formed on a surface of the cathode, and thus resistance is increased.

That is, the lithium secondary batteries of Examples 1 to 8 were found to have decreased DCIR increasing rates while exhibiting excellent lifespan characteristics.

### Evaluation Example 2: Evaluation of Battery Capacity

The lithium secondary batteries prepared in Example 1 and Comparative Examples 8 and 9 were charged with a constant current of 0.2 C rate until a voltage of 4.3 V, charged at a constant voltage until a current of 0.05 C while maintaining a voltage of 4.3 V, and then discharged with a constant current at a 0.2 C rate until a voltage of 2.8 V at a temperature of 25° C. in the 1^{st} cycle. Here, an initial capacity of each of the lithium secondary batteries was measured, and the results are shown in Table 2.

TABLE 2

| | Initial capacity (mAh) |
|---|---|
| Example 1 | 505 |
| Comparative Example 8 | 370 |
| Comparative Example 9 | 420 |

Referring to Table 2, in the case of the lithium secondary battery of Example 1, which used the Ni-rich cathode active material, the initial capacity was significantly high compared to those of the lithium secondary batteries of Comparative Examples 8 and 9 and thus may exhibit excellent battery characteristics.

As described above, according to one or more embodiments, when an amount of nickel in a cathode active material increases, a lithium secondary battery may have a certain amount of a disilane-based compound in an electrolyte while maximizing a capacity, and thus lifespan characteristics and resistance characteristics of the lithium secondary battery may improve.

It should be understood that embodiments described herein should be considered in a descriptive sense only and not for purposes of limitation. Descriptions of features or aspects within each embodiment should typically be considered as available for other similar features or aspects in other embodiments.

While an embodiment has been described, it will be understood by those of ordinary skill in the art that various changes in form and details may be made therein without departing from the spirit and scope as defined by the following claims.

What is claimed is:

1. A lithium secondary battery comprising:
a cathode;
an anode; and
an electrolyte disposed between the cathode and the anode,
wherein the cathode comprises a cathode active material represented by Formula 1,
wherein the electrolyte comprises a lithium salt, a non-aqueous solvent, and a disilane compound represented by Formula 2, and
wherein an amount of the disilane compound is about 8 percent by weight or less, based on a total weight of the electrolyte, 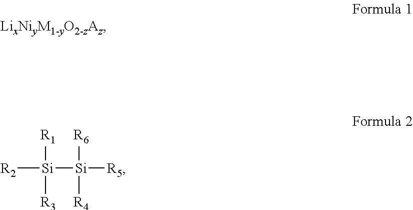
wherein, in Formulae 1 and 2,
0.95≤x≤1.2, 0.7≤y≤0.95, and 0≤z≤0.2,
M is aluminum, magnesium, manganese, cobalt, iron, chromium, vanadium, titanium, copper, boron, calcium, zinc, zirconium, niobium, molybdenum, strontium, antimony, tungsten, bismuth, or a combination thereof; and
A is at least one anion having an oxidation number of −1 or −2, and
R₁ to R₆ are each independently a substituted or unsubstituted linear or branched C₁-C₃₀ alkyl group or a substituted or unsubstituted C₆-C₆₀ aryl group,
wherein a substituent of the substituted C₁-C₃₀ alkyl group or C₆-C₆₀ aryl group, if present, is a halogen, a methyl group, an ethyl group, a propyl group, an iso-propyl group, an n-butyl group, an iso-butyl group, a t-butyl group, a trifluoromethyl group, a tetrafluoroethyl group, a vinyl group, a propenyl group, a butenyl group, or a combination thereof.

2. The lithium secondary battery of claim 1, wherein an amount of the disilane compound is in a range of about 0.1 percent by weight to about 3 percent by weight, based on the total weight of the electrolyte.

3. The lithium secondary battery of claim 1, wherein R₁ to R₆ are each independently a substituted or unsubstituted C₁-C₁₀ alkyl group, a substituted or unsubstituted C₆-C₃₀ aryl group, or a combination thereof.

4. The lithium secondary battery of claim 1, wherein the disilane compound is Compound 1, Compound 2, Compound 3, or a combination thereof:

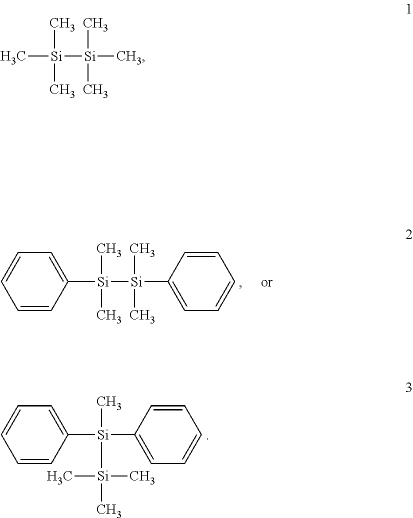

5. The lithium secondary battery of claim 1, wherein the lithium salt is lithium difluoro(oxalate)borate, LiBF₄, LiPF₆, LiCF₃SO₃, (CF₃SO₂)₂NLi, (FSO₂)₂NLi, or a combination thereof.

6. The lithium secondary battery of claim 5, wherein the lithium salt comprises lithium difluoro(oxalate)borate and LiPF₆, and an amount of the lithium difluoro(oxalate)borate is about 2 percent by weight or less, based on the total weight of the electrolyte.

7. The lithium secondary battery of claim 1, wherein the electrolyte comprises a phosphorus-containing compound, a sulfur-containing compound, or a combination thereof in an amount of about 2 percent by weight or less, based on the total weight of the electrolyte.

8. The lithium secondary battery of claim 7,
wherein the phosphorus-containing compound is a phosphine compound, a phosphate compound, a phosphite compound, or a combination thereof, and
wherein the sulfur-containing compound is a disulfonate compound.

9. The lithium secondary battery of claim 1, wherein the non-aqueous solvent comprises fluoro-ethylene carbonate.

10. The lithium secondary battery of claim 9, wherein an amount of the fluoro-ethylene carbonate is about 7 percent by volume or less, based on a total volume of the non-aqueous solvent.

11. The lithium secondary battery of claim 1, wherein the electrolyte further comprises vinylene carbonate, vinyl ethylene carbonate, maleic anhydride, succinic anhydride, or a combination thereof in an amount less than about 2 percent by weight, based on the total weight of the electrolyte.

12. The lithium secondary battery of claim 11, further comprising the vinylene carbonate, maleic anhydride, or a combination thereof in an amount less than about 2 percent by weight, based on the total weight of the electrolyte.

13. The lithium secondary battery of claim 1, wherein, in Formula 1, 0.8≤y≤0.95.

14. The lithium secondary battery of claim 1, wherein the cathode active material is represented by Formula 3 or Formula 4:
LiₓNi_{y′}Co_{1-y′-z′}Al_{z′}O₂, or Formula 3
LiₓNi_{y′}Co_{1-y′-z′}Mn_{z′}O₂, Formula 4
wherein, in Formulae 3 and 4, 0.9≤x′≤1.2, 0.85≤y′≤0.95, 0<z′<0.1, and 0<1-y′-z′<0.2.

15. The lithium secondary battery of claim 1, wherein the cathode comprises Li_{1.02}Ni_{0.85}Co_{0.1}Mn_{0.05}O₂, Li_{1.02}Ni_{0.88}Co_{0.08}Mn_{0.04}O₂, Li_{1.02}Ni_{0.88}Co_{0.08}Al_{0.04}O₂, or a combination thereof.

16. The lithium secondary battery of claim 1, wherein the anode comprises
an anode active material comprising a metal alloyable with lithium, or
a carbonaceous anode active material.

17. The lithium secondary battery of claim 16, wherein the anode active material comprising the metal alloyable with lithium comprises silicon, a silicon-carbon composite material comprising Si particles, a compound of the formula SiO_{a′} wherein 0<a′<2, or a combination thereof.

18. The lithium secondary battery of claim 16, wherein the carbonaceous anode active material comprises graphite.

19. The lithium secondary battery of claim 1, wherein a direct current internal resistance increasing rate after 200 charging/discharging cycles at a temperature of about 450C is less than about 140%.

20. The lithium secondary battery of claim 1, wherein a cell energy density is about 500 watt-hours per liter or greater.
